(19) United States
(12) Patent Application Publication
(10) Pub. No.: US 2018/0271297 A1
(43) Pub. Date: Sep. 27, 2018

(54) SUPPORTING DEVICE ADJUSTABLE BY AN ELECTRIC MOTOR

(71) Applicant: de Werth Group AG, Zurich (CH)

(72) Inventor: Eckhart DEWERT, Goldingen (CH)

(21) Appl. No.: 15/802,248

(22) Filed: Nov. 2, 2017

Related U.S. Application Data
(63) Continuation of application No. PCT/EP2016/057445, filed on Apr. 5, 2016.

(30) Foreign Application Priority Data
May 4, 2015 (DE) 10 2015 106 883.4

(51) Int. Cl. A47C 20/04; A47C 19/04; A61G 7/015; A61G 7/018

(52) U.S. Cl. CPC A47C 20/041; A61G 7/018; A61G 7/015; A47C 19/045

(57) ABSTRACT

A supporting device adjustable by an electric motor and intended for supporting an upholstered unit of a piece of furniture for sitting and/or lying on, in particular for supporting a mattress of a bed. The supporting device has a main body and a supporting arrangement for supporting the upholstered unit and also an adjustment device for adjusting the supporting arrangement in respect of inclination and/or height relative to the main body. The adjustment device has at least one scissor-lift-like, Bowden-cable-actuable lifting arrangement, which acts between the main body and the supporting arrangement.

### CROSS-REFERENCE TO RELATED APPLICATIONS

This application is a continuation of application no. PCT/EP2016/057445, filed Apr. 5, 2016, and this application claims the priority of German Application No. 10 2015 106 883.4, filed May 4, 2015, and each of which is incorporated herein by reference.

### FIELD OF THE INVENTION

The invention relates to a supporting device adjustable by an electric motor for supporting an upholstered unit of a piece of furniture for sitting and/or lying on.

### BACKGROUND OF THE INVENTION

Such supporting devices are generally known for example in the form of slatted frames.

In particular in the case of a care bed there is a requirement to adjust the height of a supporting arrangement on which the mattress of the care bed rests.

DE 94 06 7026 U1 discloses a supporting device of the relevant type which is adjustable by an electric motor and has a main body and a supporting arrangement for supporting the upholstered unit. The supporting device known from this document is configured as a slatted frame, wherein the supporting arrangement has a head part, a central part and a foot part. The supporting device also has adjustment means for adjusting the inclination and/or the height of the supporting arrangement relative to the main body.

A supporting device in the form of a seat is known from EP 1 708 595 B1, in which the inclination and the height of the seat surface relative to the main body can be adjusted by means of a pivot shaft mechanism.

A lifting apparatus which can be used in particular for hospital and care beds, slatted frames and television chairs, and by means of which a component of an item of furniture can be adjusted in height relative to a main body of the item of furniture, is known from EP 0 606 575 A1. The adjustment means has a scissor lift which can be actuated by means of a spindle drive.

### OBJECTS AND SUMMARY OF THE INVENTION

An object of the invention is to provide a supporting device adjustable by an electric motor and intended for supporting an upholstered unit of a piece of furniture for sitting and/or lying on, which has a simple and robust construction and is suitable for the application of strong forces.

This object is achieved by the invention set forth herein.

This object is achieved by the invention including a supporting device adjustable by an electric motor and intended for supporting an upholstered unit of a piece of furniture for sitting and/or lying on, which includes a main body and a supporting arrangement for supporting the upholstered unit. An adjustment device for adjusting an inclination and/or height of the supporting arrangement relative to the main body is provided. The adjustment device has at least one lifting arrangement which is like a scissor lift and can be actuated by a Bowden cable and which acts between the main body and the supporting arrangement.

For adjustment of the inclination and/or height of the supporting device relative to the main body, the supporting device according to the invention has at least one lifting arrangement which is like a scissor lift, can be actuated by a Bowden cable and acts between the main body and the supporting arrangement. In this case the invention skillfully combines the advantages of the operating principle of a scissor lift and the operating principle of a Bowden cable. With regard to the operating principle of a scissor lift it is advantageous in the context of the invention that a corresponding lifting arrangement has a simple and robust construction and is suitable for the application of strong forces. This advantage is further enhanced by the Bowden cable actuation provided according to the invention, because Bowden cables are also suitable for the application of strong forces. A further advantage of a Bowden cable actuation is that, with a corresponding length of the Bowden cable or the Bowden cables, the electric motor-powered driving apparatus can be arranged at any suitable location. In particular in the case of care beds, this opens up the possibility of arranging the electric motor-powered driving apparatus at a location at which a supply of liquid is not expected. In this way there is no need for costly sealing, because the essential functional components of the electric motor-powered driving apparatus can be arranged at a moisture-proof location.

The number and the spatial arrangement of the lifting arrangements on the main body or on the supporting arrangement are selectable within further limits. In this respect an advantageous further embodiment of the invention provides that at least two lifting arrangements are provided which are spaced apart from one another transversely with respect to the longitudinal direction of the supporting arrangement. For example, and in particular, if the supporting arrangement is designed like a frame and has longitudinal spars spaced apart from one another transversely with respect to the longitudinal direction, each lifting arrangement can engage on one of the longitudinal spars, so that with an adjustment of the supporting arrangement relative to the main body a twisting of the supporting arrangement is reliably avoided.

According to the invention is sufficient in principle if the lifting arrangements are arranged on a line when viewed in the longitudinal direction of the supporting device. In this way the supporting arrangement can be raised or lowered on the side on which the lifting arrangements are arranged, so that in this way the inclination of the supporting arrangement relative to the main body is adjustable.

In order to be able to adjust the supporting arrangement not only in its inclination but also in its height relative to the main body, another advantageous further embodiment provides at least two lifting arrangements which are spaced apart from one another in the longitudinal direction of the supporting arrangement. In such an embodiment the lifting arrangements which are spaced apart from one another in the longitudinal direction of the supporting arrangement can be controlled synchronously, so that the supporting arrangement can be adjusted in height. However, it is also possible to control the lifting arrangement asynchronously, so that the inclination of the supporting arrangement is then adjusted. For example, and in particular, four lifting arrangements can be provided, each of which acts on the supporting arrangement in the region of one of the corners of a rectangle defining the supporting arrangement.

Another advantageous further embodiment of the invention provides that the supporting arrangement has longitudinal spars which are laterally spaced apart from one another, and that the lifting arrangements act on the longitudinal spars.

Another advantageous further embodiment of the invention provides that each lifting arrangement has an erecting lever which can be erected under the pulling action of a Bowden cable, in such a way that the supporting arrangement can be raised or is raised during erection of the erecting lever or can be adjusted or is adjusted in its inclination. A corresponding erecting lever mechanism has a relatively simple construction and is robust.

A further embodiment of the aforementioned embodiment provides that the ends of the erecting lever are mounted, on the one hand, so as to pivot on the main body about axes which are parallel to one another and, on the other hand, are mounted on the supporting arrangement.

In the aforementioned embodiment the erecting lever is advantageously mounted so as to pivot on a first rotary bearing on the main body.

In order to produce an arrangement which in a particularly simple manner and with a particularly small number of components operates according to the operating principle of a scissor lift, an extraordinarily advantageous further embodiment of the invention provides a bracket, of which the ends pivot about pivot axes parallel to one another, and which is connected, on the one hand, to a second rotary bearing on the main body and, on the other hand, to the erecting lever remote from the ends thereof.

An advantageous further embodiment of the aforementioned embodiment provides that the first rotary bearing and the second rotary bearing are mounted on the main body so as to be movable in translation relative to one another along a linear axis. In this case a translational movement of the first rotary bearing and of the second rotary bearing relative to one another can be achieved in that both rotary bearings can be moved in translation. However, in this respect an advantageous further embodiment provides that that with regard to the adjustment of the supporting arrangement relative to the main body the first rotary bearing is arranged movably and the second rotary bearing is arranged stationary on the main body. In this way friction occurring during the translational movement of the rotary bearing is minimized.

A particularly advantageous further embodiment of the invention provides that the erecting lever or a component connected thereto, during its translational movement relative to the second rotary bearing, runs onto a first erecting element and is erected. In this embodiment the erecting lever is pulled against the erecting element by the pulling action of the Bowden cable. Thus, in a particularly simple manner it is possible to overcome the dead center at which the supporting device is in the starting position of the adjusting movement, in which the supporting device is unadjusted relative to the main body, and thus, for example, the supporting arrangement is located in a lowered position relative to the main body.

According to the kinematics selected in each case, the erecting element onto which the erecting lever runs can be arranged fixedly, whilst the first rotary bearing and thus the erecting lever is mounted so as to be movable along the translational axis. In this respect a particularly advantageous embodiment of the invention with regard to the achieved kinematics provides that the erecting element is mounted so as to be movable along the translational axis relative to the first rotary bearing.

Another advantageous further embodiment of the invention provides that under the pulling action of the Bowden cable the distance between the first rotary bearing and the erecting element decreases, in such a way that the erecting lever runs onto the erecting element and is erected.

According to the invention at least one Bowden cable drive is provided for actuating the lifting element. The structure and mode of operation of a corresponding Bowden cable drive are known from EP 2 792 277 A1, the entire content of the disclosure of which is incorporated by reference into the present application.

The invention is explained in greater detail with reference to the appended drawings in which an embodiment of a supporting device according to the invention is illustrated. In this case all features described in the description, depicted in the drawings and claimed in the claims, when considered individually and also in any suitable combination with one another form the subject matter of the invention, regardless of the way they are combined in the claims and regardless of their description or depiction in the drawings. The content of the disclosure of the present application also includes combinations of the claims, in which individual features or a plurality of features of the claims are omitted or are replaced by other features.

Relative terms such as left, right, up, and down are for convenience only and are not intended to be limiting.

### BRIEF DESCRIPTION OF THE DRAWINGS

In the drawings:

FIG. 1 shows a perspective view of a first illustrative example of supporting device in the form of a slatted frame in an unadjusted starting position,

FIG. 2 shows, in the same depiction as FIG. 1, the illustrative example according to FIG. 1 in an end position of the adjusting movement of an upper body support part and of a leg support part,

FIG. 3 shows, in the same depiction as FIG. 1, the illustrative example according to FIG. 1 in which some components are omitted for reasons of clarity of illustration,

FIG. 4 shows, in the same depiction as FIG. 2, details of a driving apparatus of the supporting device according to FIG. 1,

FIG. 5 shows, in the same depiction as FIG. 4, details of a driving apparatus from another perspective,

FIG. 6 shows, in the same depiction as FIG. 5, but on an enlarged scale, a detail of FIG. 5,

FIG. 7 shows, in the same depiction as FIG. 5, the driving apparatus according to FIG. 5, wherein further components of the supporting device are omitted for clarification of the adjustment of the head support part relative to the upper body support part,

FIG. 8 shows, in the same depiction as FIG. 7, but from a different perspective, the supporting device according to FIG. 2, wherein further components of the supporting device are omitted,

FIG. 9 shows a detail of FIG. 8 from a different perspective, but on an enlarged scale,

FIG. 10 shows, in a perspective depiction, a second illustrative example of a supporting device in the starting position of the adjusting movement, in which the support parts span a horizontal support plane,

FIG. 11 shows, in the same depiction as FIG. 10, the supporting device according to FIG. 10, wherein the support parts are located in an adjusted position which lies between the starting position and the end position of the adjusting movement,

FIG. 12 shows, in the same depiction as FIG. 10, the supporting device according to FIG. 10, wherein the support parts are located in the end position of the adjusting movement,

FIG. 13 shows, in the same depiction as FIG. 10, the supporting device according to FIG. 10, wherein components of the supporting device are omitted for clarification of the structure of the driving apparatus,

FIG. 14 shows, in the same depiction as FIG. 13, but in a somewhat different perspective, the supporting device according to FIG. 10,

FIG. 15 shows, in the same depiction as FIG. 13, the supporting device according to FIG. 10 in the end position of the adjusting movement,

FIG. 16A shows a perspective view of an embodiment of a supporting device according to the invention in a kinematic phase,

FIG. 16B shows a perspective view of an embodiment of a supporting device according to the invention in a different kinematic phase,

FIG. 16C shows a perspective view of an embodiment of a supporting device according to the invention in a different kinematic phase,

FIG. 17A shows, from a different perspective, a detail of FIG. 16 in a kinematic phase of the adjusting movement,

FIG. 17B shows, from a different perspective, a detail of FIG. 16 in a different kinematic phase of the adjusting movement,

FIG. 17C shows, from a different perspective, a detail of FIG. 16 in a different kinematic phase of the adjusting movement,

FIG. 17D shows, from a different perspective, a detail of FIG. 16 in a different kinematic phase of the adjusting movement,

FIG. 18A shows the supporting device of FIG. 16 in a kinematic phase of the adjusting movement, wherein components of the supporting device are omitted for reasons of clarity of illustration,

FIG. 18B shows the supporting device of FIG. 16 in a different kinematic phase of the adjusting movement, wherein components of the supporting device are omitted for reasons of clarity of illustration,

FIG. 18C shows the supporting device of FIG. 16 in a different kinematic phase of the adjusting movement, wherein components of the supporting device are omitted for reasons of clarity of illustration,

FIG. 19 shows, in a similar depiction to FIG. 17C, the detail according to FIG. 17C, wherein components of the supporting device are omitted for reasons of clarity of illustration, and

FIG. 20 shows, on an enlarged scale, components of a lifting arrangement of the supporting device according to FIG. 16.

### DETAILED DESCRIPTION OF THE INVENTION

In the figures of the drawings the same or corresponding components are provided with the same reference signs. The drawings schematically depict an embodiment of a supporting device according to the invention. For reasons of clarity of illustration, components of the supporting device are omitted in individual figures of the drawing. It is conceivable that these components can be complemented in an appropriate manner.

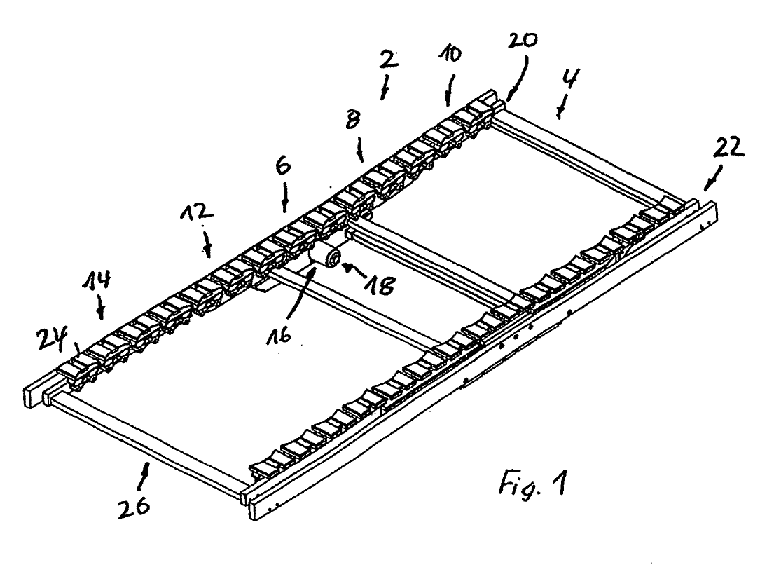

For explanation of a first illustrative example of the invention reference is made below to FIGS. 1 to 9.

FIG. 1 shows a first illustrative example of a supporting device 2 according to the invention which is adjustable by an electric motor, which in this illustrative example is formed as a slatted frame. The supporting device 2 has a main body 4 which has support parts on which a mattress of a bed is supported during use of the supporting device 2. For reasons of clarity of illustration, the mattress is completely omitted in the drawing.

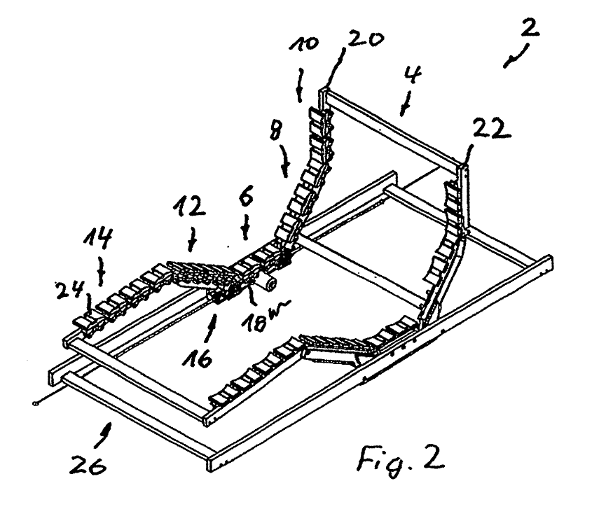

In the depicted illustrative example (cf. FIG. 2) the supporting device 2 has a stationary central support part 6, to which an upper body support part 8 is connected in an articulated manner and so as to pivot about a horizontal pivot axis, and a head support part 10 is connected, in an articulated manner and so as to pivot about a horizontal pivot axis, to the end of the upper body support part remote from the central support part 6. A leg support part 12 is connected, in an articulated manner and so as to pivot about a horizontal pivot axis, to the end of the central support part 6 remote from the upper body support part 8, and a calf support part 14 is connected, in an articulated manner and so as to pivot about a horizontal pivot axis, to the end of the leg support part remote from the central support part 6.

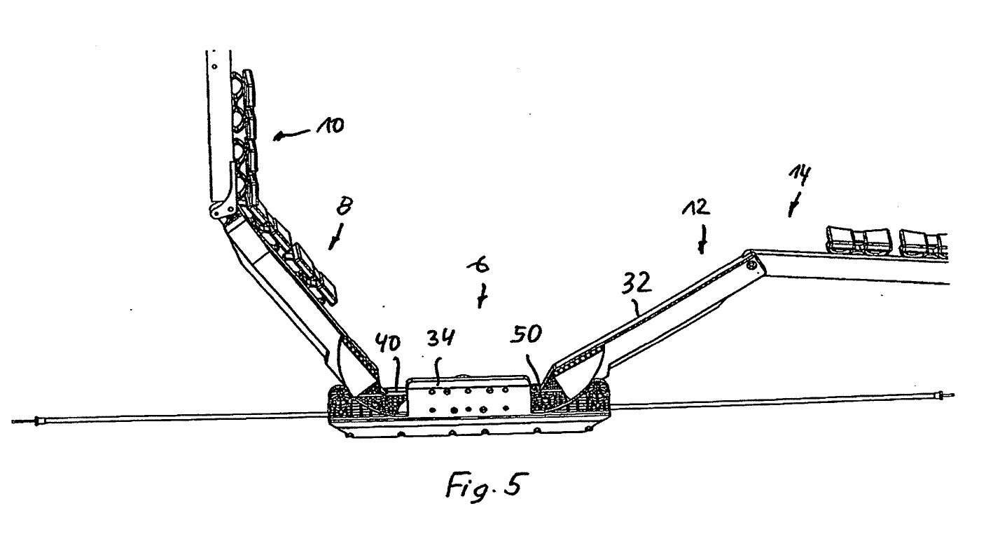

For the pivoting adjustment of the support parts 6 to 14 relative to one another an electric motor-powered driving apparatus 16 is provided, which has a drive unit 18 arranged on a first longitudinal spar 20 on the central support part 6. A further drive unit 18′ of the electric motor-powered driving apparatus 16 is arranged on a second longitudinal spar 22 spaced apart from the first longitudinal spar 20 transversely with respect to the longitudinal direction of the supporting device 2. The drive units 18, 18′ are explained in greater detail below with reference to FIG. 5 to 9.

Slat holders, on which slats are held which spring during use of the supporting device 2 and on which the mattress is supported, are connected to the supporting parts 6 to 14. In the drawings (cf. FIG. 1 and FIG. 2) only one slat holder is provided with the reference numeral 24. The springy slats are not depicted in the drawings for reasons of clarity of illustration.

FIG. 1 shows the supporting device 2 in an unadjusted starting position of the support parts 6 to 14, in which the support parts 6 to 14 with one another span a horizontal or approximately horizontal support plane for supporting the mattress.

FIG. 2 shows the supporting device 2 in an end position of the adjusting movement, in which the upper body support part 8 with the head support part 10 and also the leg support part 12 with the calf support part 14 are pivoted to a maximum extent relative to the central support part 6 and thus are adjusted. The starting position of the supporting device 2 corresponds to a reclined position of the supporting device 2, whereas the end position in FIG. 2 corresponds to a sitting position. Any adjusted position is possible between the starting position and the end position.

For reasons of clarity of illustration, voltage supply and control means for controlling the drive unit 16 are not depicted in the drawings. However, the structure and the mode of operation of a corresponding voltage supply and control means are generally known to the person skilled in the art and therefore are not explained in greater detail here. According to the invention the upper body support part 8 is constructed and configured in such a way that the pivot axis is mounted so as to be movable in translation in the longitudinal direction of the supporting device 2. This avoids compression of the mattress relative to the central support part 6 during the pivoting adjustment of the upper body support part 8. Thus, even in the adjusted position of the upper body support part 8 a high degree of convenience is ensured for a user of the supporting device 2. As can also be seen from a comparison of FIGS. 1 and 2, the consequence of the mounting of the pivot axis so as to be movable in translation is that, during an adjustment from the starting position in the direction of the end position, the distance between the slat holders which are arranged adjacent to one another in the starting position (cf. FIG. 1) is increased on the central support part 6 and the upper body support part 8. In this way compression of the mattress is avoided.

The same also applies to an adjustment of the leg support part 12 relative to the central support part 6. The pivot axis associated with the leg support part 12 is likewise mounted so as to be movable in translation in the longitudinal direction of the supporting device 2. Accordingly, during a pivoting adjustment of the leg support part 12 relative to the central support part 6 the distance between the slat holders increases on the central support part 6 and the leg support part 12, which in the starting position of the adjusting movement (cf. FIG. 1) are arranged adjacent to one another. Thus, compression of the mattress is also avoided in the region of the leg support part 12. Because of the adjustment and translational movement of the upper body support part 8 and of the leg support part 12 independently of one another relative to the central support part 6, in each adjusted position a compression of the mattress is avoided and thus in all adjusted positions of the supporting device 2 the mattress decompresses.

As can be seen from FIGS. 1 and 2, the supporting device 2 has an outer frame 26 to which the main body 4 is fastened.

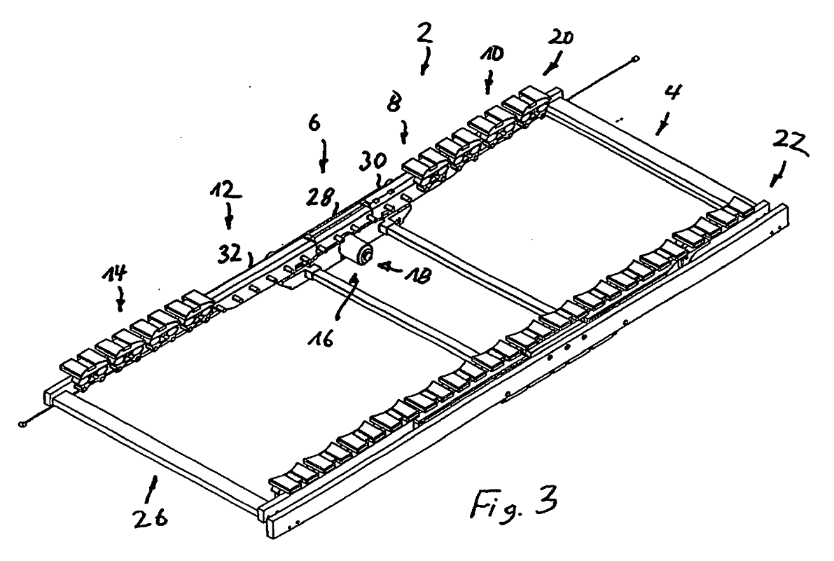

FIG. 3 shows the supporting device 2 according to FIG. 1, wherein for reasons of clarity of illustration slat holders are omitted on the first longitudinal spar 20 in the region of the central support part 6, the upper body support part 8 and the leg support part 12, so that first longitudinal spars 28, 30, 32 of the central support part 6 or of the upper body support part 8 or of the leg support part 12 can be discerned.

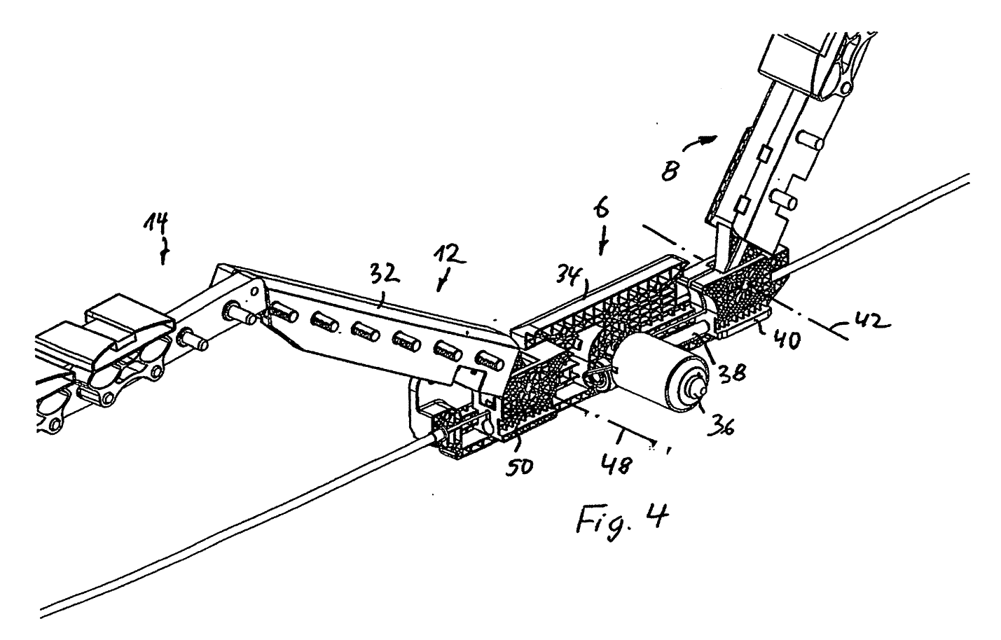

With reference to FIG. 4 to 6, the structure of the supporting device 2 according to the invention is explained in greater detail with regard to the driving apparatus 16.

Only the drive unit 18 associated with the first longitudinal spar 20 is explained in greater detail below. The drive unit associated with the second longitudinal spar 22 has a corresponding structure and therefore is not explained in greater detail here.

The drive unit 18 has a base element 34 which in this embodiment is formed by an injection molded part made of plastic and on which the components of the drive unit 18 are arranged or mounted. On the base element 34 is arranged an electric motor 36, the output shaft of which is in rotary drive connection with a threaded spindle 38 mounted in a stationary manner and so that it can be driven in rotation on the base element 34. In the illustrated embodiment the rotary drive connection between the output shaft of the electric motor 36 and the threaded spindle 38 is produced by means of a worm gear. The output element of the drive unit 18 is formed by a spindle nut 40 which is arranged so as to be non-rotatable and movable on the threaded spindle 38 in the axial direction thereof.

The spindle nut 40 forms a carriage on which is mounted a pivot axis 42, about which the upper body support part 8 is pivotable relative to the central support part 6 (cf. FIG. 3 and FIG. 4).

FIG. 5 shows the drive unit 18 from the side facing away from the electric motor 36.

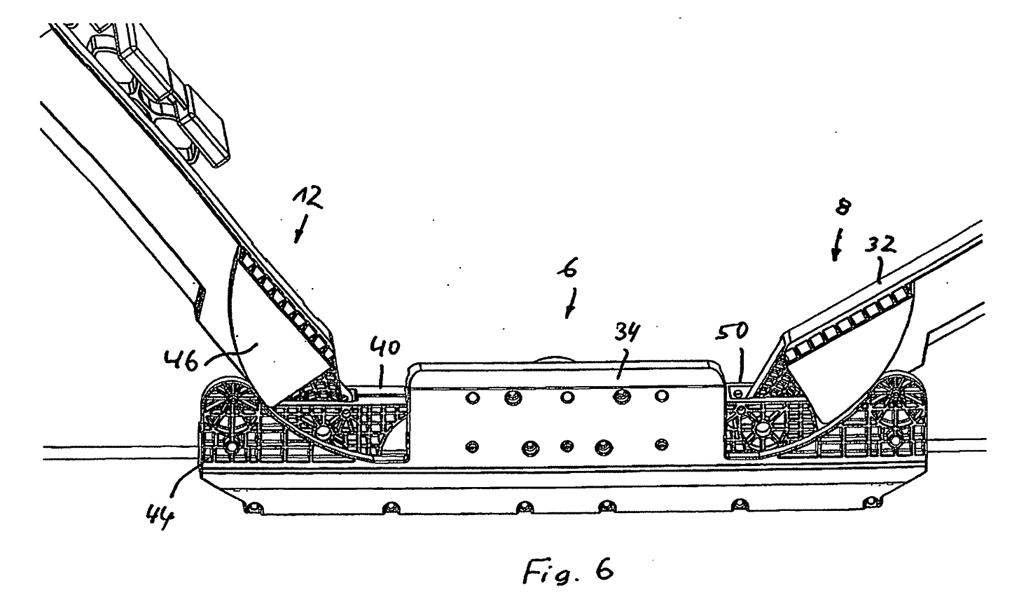

FIG. 6 shows the drive unit 18 in the same depiction as FIG. 5, but on an enlarged scale.

The adjustment of the upper body support part 8 (second support part) relative to the central support part 6 (first support part) is accomplished in such a way that during the translational movement the second support part or a component connected thereto runs onto a first erecting element and is pivoted. As is explained with reference to FIG. 4, by means of the spindle drive 38, 14 a translational movement of the spindle nut 40 and thus of the upper body support part 8 relative to the central support part 6 is effected. In the illustrated embodiment the pivoting movement of the upper body support part 8 relative to the central support part 6 is effected in that a first erecting element 44 is arranged laterally adjacent to the translational movement path of the spindle nut 40 and thus of the upper body support part 8, onto which a second erecting element 46 connected to the upper body support part 8 runs on, so that in this case the upper body support part 8 pivots relative to the central support part 6.

In the depicted illustrative example, the first erecting element 44 is formed in one piece with the base element 34. The first erecting element 44 is formed in one piece with the first longitudinal spar 30 of the upper body support part 8, wherein in the illustrated embodiment the first longitudinal spar 30 and the second erecting element 46 in the illustrated embodiment are likewise formed by an injection molded part made of plastic. Thus, in the illustrated embodiment the second erecting element 46 is connected non-pivotably to the upper body support part 8. In a modification of this embodiment, however, the second erecting element can also be movably connected to the upper body support part 8 if in the required manner an erection of the upper body support part 8 and thus a pivoting thereof relative to the central support part 6 is effected.

As can be seen in particular from FIG. 6, in the depicted illustrative example the erecting elements 44, 46 are formed in cross-section as cam members, wherein the erecting elements 44, 46 in the depicted embodiment are formed in cross-section in a substantially complementary manner. As can be seen from FIG. 6, the upper body support part 8 is arranged horizontally in the starting position (cf. FIG. 1), wherein the dead center of the pivoting adjustment of the upper body support part 8 is overcome during the translational movement of the spindle nut 40 and thus the pivoting movement is carried out.

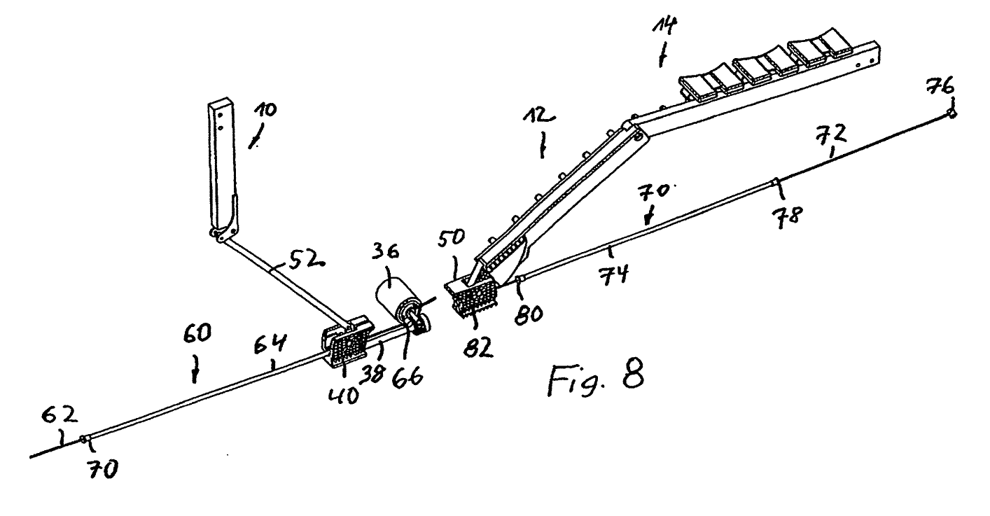

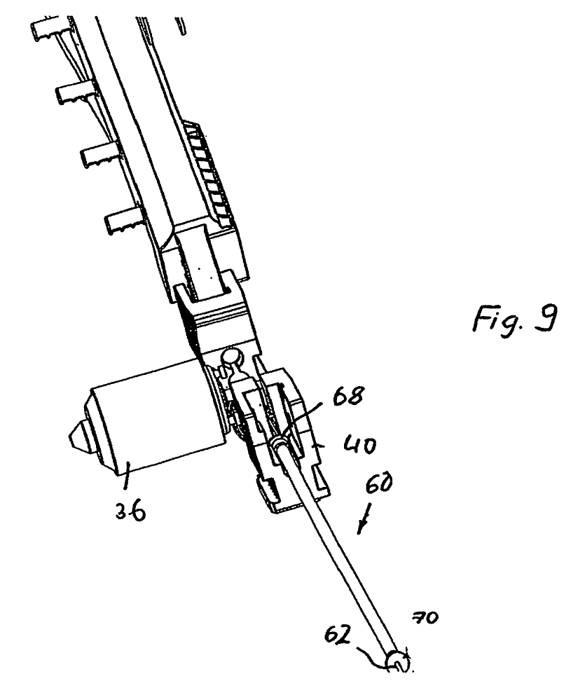

In order to avoid overcoming the upper body support part 8 during the adjustment, the translational movement of the carriage 40, which is formed by the spindle nut 40, of the first drive unit 18 is transmitted to a carriage, which is mounted so to be movable in translation, of the drive unit associated with the second longitudinal spar 22. For this purpose, a synchronizing means is provided which is explained in greater detail below with reference to FIG. 8 to 9. This carriage, which is mounted so to be movable in translation on the drive unit provided on the second longitudinal spar 22, is powerless, so that the adjustment of the two longitudinal spars of the upper body support part 8 is effected by the electric motor 36, wherein the synchronizing means ensures that twisting of the upper body support part 8 does not occur.

The adjustment of the leg support part 12 takes place in a corresponding manner. For this purpose, the first longitudinal spar 32 of the leg support part 12 is mounted so as to pivot about a pivot axis 48 on a carriage 50 which is mounted so to be movable in translation on the base element 34 of the drive unit 18.

The drive unit associated with the second longitudinal spar 22 has, corresponding to the drive unit 18, an electric motor which drives a carriage formed by the spindle nut of a spindle drive, as has been described above for the carriage 40. Translational movements of this driven carriage of the drive unit associated with the second longitudinal spar 22 are transmitted to the carriage 50 by the synchronizing means explained in greater detail below. Thus, the carriages associated with the upper body support part 8 are driven by the electric motor 36, whereas the carriages associated with the leg support part 12 are driven by the electric motor which is associated with the drive unit associated with the second longitudinal spar 22. In other words, the electric motor 36 effects an adjustment of the upper body support part 8 with the head support part 10, whereas the corresponding electric motor associated with the second longitudinal spar 22 effects an adjustment of the leg support part with the calf support part.

Because of the pivotably movable connection of the calf support part 14 to the leg support part 12, the calf support part 14 pivots due to its gravity relative to the leg support part 12 when the leg support part is pivoted. The end position of the adjusting movement (cf. FIG. 2) is defined by a stop acting between the leg support part 12 and the calf support part 14.

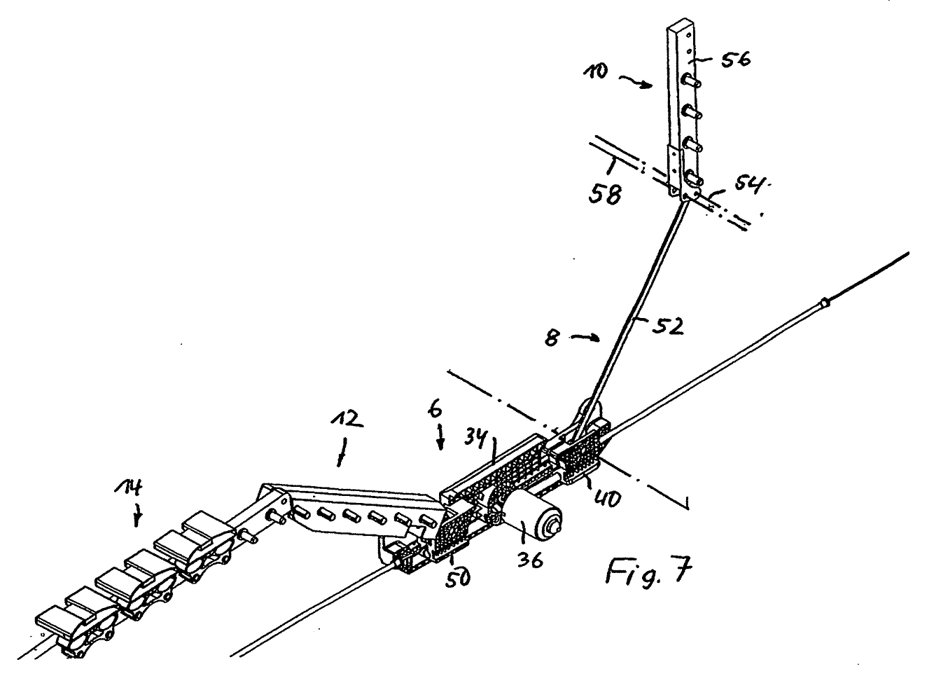

The adjustment of the head support part 10 relative to the upper body support part 8 is explained below with reference to FIG. 7.

A rod-like adjusting element 52, of which one end is pivotably movable and is mounted on the carriage 40 coaxially with the pivot axis 42, is provided for adjustment of the head support part 10. The other end of the adjusting element 52 is mounted around a pivot axis 44 on a first longitudinal spar 56 of the head support part 10. The pivot axis 54 is mounted eccentrically with respect to a pivot axis 58 about which the head support part 10 is pivotable relative to the upper body support part 8. Because of the arrangement of the pivot axis 54 eccentrically with respect to the pivot axis 58, during pivoting of the upper body support part 8 relative to the central support part 6 the head support part 10 pivots relative to the upper body support part 8 until the end position of the adjusting movement is reached (cf. FIG. 2).

The return of the support parts 8 to 14 relative to the central support part 6 into the starting position (cf. FIG. 1) takes place under the weight of the support parts 6 to 12, possibly additionally under the load of a person resting on the supporting device 2, wherein the driving apparatus remains switched on.

In the depicted illustrative example, the first erecting element 44 is arranged stationary—relative to the central support part 6 (first support part)—whereas the second erecting element 46 is arranged movably. However, according to the respective requirements it is also possible to arrange both erecting elements 44, 46 movably relative to the first support part.

The synchronizing means according to the invention has a Bowden cable 60 (cf. FIG. 8) which has a traction cable (core) 62 accommodated in a sheath 64 which is flexible, but is pressure-resistant in the pulling direction. One end 66 of the traction cable 62 is secured to the stationary base element 34. The end 68 of the sheath facing the end 66 of the traction cable 62 is secured non-displaceably to the carriage 40, as can be seen from FIG. 9.

As explained above, a carriage which corresponds to the carriage 40, but is designed without a drive, is provided on the second longitudinal spar 22.

The other end of the traction cable 62 remote from the end 66 is secured non-displaceably to this driveless carriage, whereas the other end 70 of the sheath remote from the end 68 is secured non-displaceably to a base element which is associated with the second longitudinal spar 22 and on which the driveless carriage is mounted so as to be movable in translation. For reasons of clarity of depiction, the connection of the traction cable 62 and of the end 70 of the sheath to this driveless carriage is not shown in the drawings.

In the starting position of the adjusting movement the distance of the spindle nut 40 from the end 66 of the traction cable secured on the base element 34 is minimal. During the adjusting movement the spindle nut 40 in FIG. 8 moves in translation towards the left, wherein the upper body support part 8 pivots in the previously described manner.

During the translational movement of the spindle nut 40 in FIG. 8 towards the left the traction cable 62 of the Bowden cable 60 remains stationary, whilst the sheath in FIG. 8 is displaced towards the left. Because of this displacement of the sheath the distance of the end 70 of the Bowden cable 60 from the associated end of the traction cable 62 decreases. Since the end 70 is secured to the further base element associated with the second longitudinal spar 22 and the traction cable is secured to the driveless carriage associated with this base element, this carriage moves synchronously with the carriage formed by the spindle nut 40. In this way the adjusting force applied by the electric motor 36 is introduced synchronously or approximately synchronously into the two longitudinal spars of the upper body support part 8, so that twisting of the upper body support part 8 during the adjusting movement is avoided.

As already described above, the drive unit associated with the second longitudinal spar 22 likewise has a carriage in the form of a spindle nut driven by an electric motor, wherein the configuration corresponds to the configuration described for the base element 34, the electric motor 36 and the spindle drive 38, 40. A Bowden cable 70 having a traction cable 72 and a sheath 74 serves as synchronizing means. According to the configuration described for the end 66 of the Bowden cable 60, the end 76 of the Bowden cable 70 is secured to the base element 34 associated with the second longitudinal spar 22, whilst the end 78 of the sheath 74 facing the end 76 of the traction cable 72 is secured to this spindle nut. The end 80 of the sheath 74 remote from the end 78 is secured to the base element 34 which is not shown in FIG. 8, whilst the end of the traction cable 72 remote from the end 76 is secured to a driveless carriage 82 which is associated with the leg support part 12.

During a movement of the spindle nut associated with the second longitudinal spar 22 in the direction of the end position of the adjusting movement, the distance between the carriage 82 and the end 80 of the sheath 74 decreases, so that the carriage 82 moves towards the right in FIG. 8. In this way is the adjusting force applied by the electric motor associated with the second longitudinal spar 22 is introduced synchronously into the two longitudinal spars of the leg support part 12.

Thus, as already explained above, the electric motor 36 associated with the first longitudinal spar 20 effects an adjustment of the upper body support part 8 with the head support part 10 relative to the central support part 6, whilst the electric motor associated with the second longitudinal spar 22 effects an adjustment of the leg support part 12 with the calf support part 14.

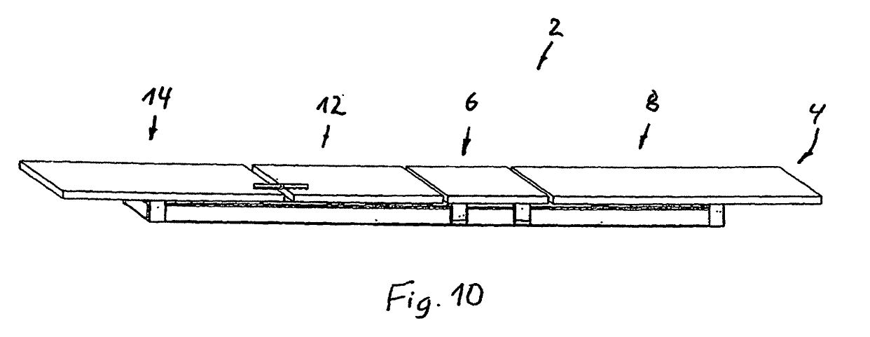

Reference is made below to FIG. 10 to 15.

FIG. 10 shows the second illustrative example in a view corresponding to FIG. 1. The second illustrative example differs from the first illustrative example firstly in that the supporting device 2 is designed for supporting a box-spring mattress. Since in such a box-spring mattress the springing, which in a slatted frame is provided by the resilient slats, is integrated into the mattress, in the embodiment according to FIG. 10 the support parts are plate-shaped.

In the depicted illustrative example, the supporting device is of 4-membered construction and has a stationary central support part 6 to which, on the one hand, an upper body support part 8 and, on the other hand, a leg support part 12 in addition to a calf support part 14 is connected so as to be pivotably adjustable.

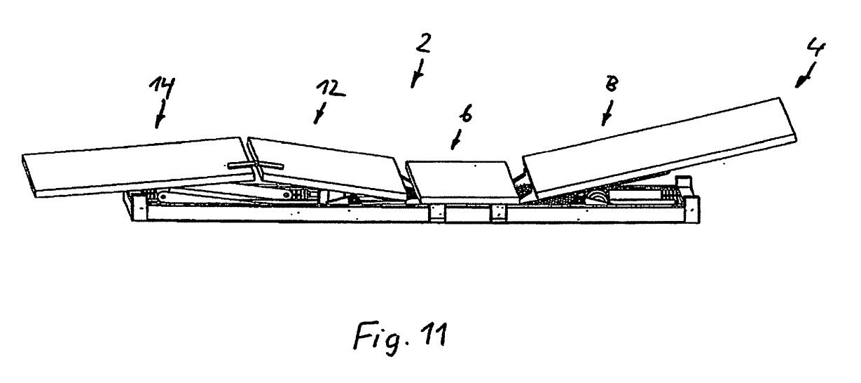

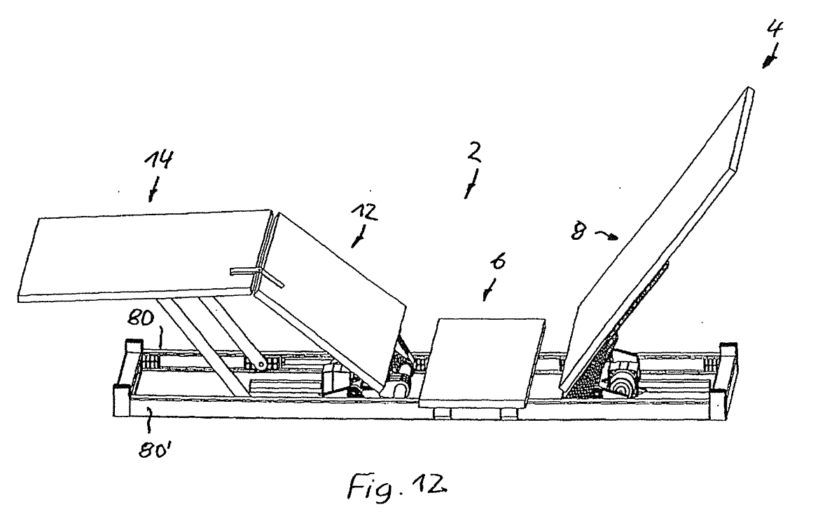

FIG. 11 shows the supporting device 2 in an adjusted position, which is between the starting position of the adjusting movement depicted in FIG. 10 and an end position of the adjusting movement depicted in FIG. 12 in which the support parts 8, 12, 14 are adjusted to a maximum extent relative to the central support part 6.

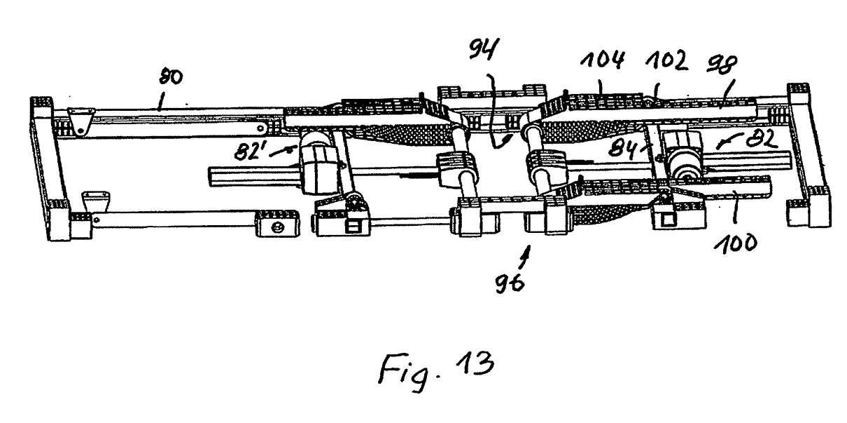

The driving apparatus 16 of the second embodiment is explained in greater detail below with reference to FIG. 13 to 15. For reasons of clarity of illustration, various components of the supporting device 2 are omitted in FIG. 13 to 15.

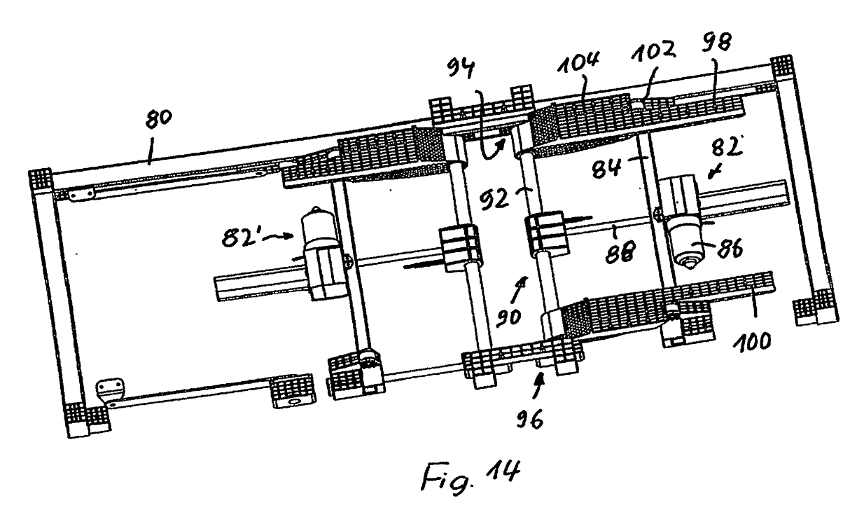

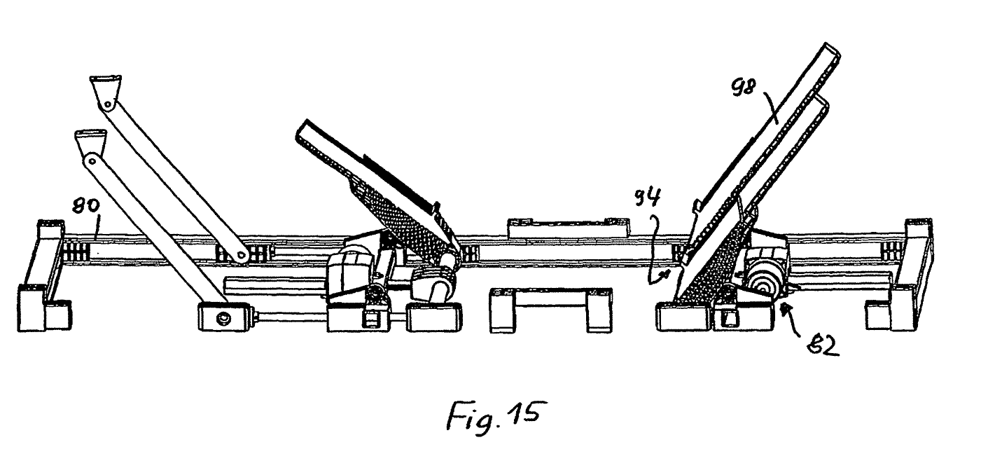

FIGS. 13 and 14 show the supporting device 2 in the starting position from different perspectives, whilst FIG. 15 shows the supporting device 2 in the end position of the adjusting movement.

In the second illustrative example the outer frame 26 has longitudinal spars 80, 80′ which in each case are formed by a C-profile. The openings of the C-profiles of the longitudinal spars 80, 80′ are facing one another. A drive unit 82 is provided for adjustment of the upper body support part 8 relative to the central support part 6, whilst a further drive unit 82′ is provided for adjustment of the leg support part 12 with the calf support part 14 relative to the central support part 6. The drive 82 is exclusively explained in greater detail below. The drive unit 82′ has a corresponding construction, and the components thereof are provided with reference numerals which correspond to the reference numerals of the drive unit 82.

The drive unit has an electric motor 86 which is arranged on a stationary first transverse member 84 and is in rotary drive connection with a spindle nut which can be driven in rotation and is arranged on a torsion-free threaded spindle 88 which is movable in the axial direction. The end of the threaded spindle 88 remote from the electric motor 86 and thus from the spindle nut is connected non-displaceably to a carriage 90 which has a second transverse member 92, the ends of which are connected to carriage elements 94, 96 which are in each case caught and guided so as to be movable in translation in the C-profiles of the longitudinal spars 80, 80′. Longitudinal spars 98, 100 are mounted on the transverse member 92 so as to be pivotable about a pivot axis defined thereby.

For adjustment of the upper body support part 8 relative to the central support part 6, the electric motor 86 drives the spindle nut in such a way that the carriage 90 moves in translation in the direction of the first transverse member 84. A first erecting element 102, which for pivoting of the upper body support part 8 interacts with a second erecting element 104 connected non-pivotably to the longitudinal spar 98, is arranged on the first transverse member 84. Thus, the fundamental principle, according to which the upper body support part 8 simultaneously carries out a translational and a pivoting movement, is the same as in the first embodiment.

The same applies to the other longitudinal spar 100 of the upper body support part 8.

It can be seen from FIGS. 14 and 15 that the travel of the translational movement of the upper body support part 8 during the adjustment is greater than in the first embodiment. This takes account of the fact that in the case of a box-spring mattress a greater travel is necessary in order to avoid compression.

In the second embodiment compression of the mattress is also avoided both in the region of the upper body support part 8 and also in the region of the leg support part 12.

FIG. 15 shows the supporting device 2 in the end position of the adjusting movement.

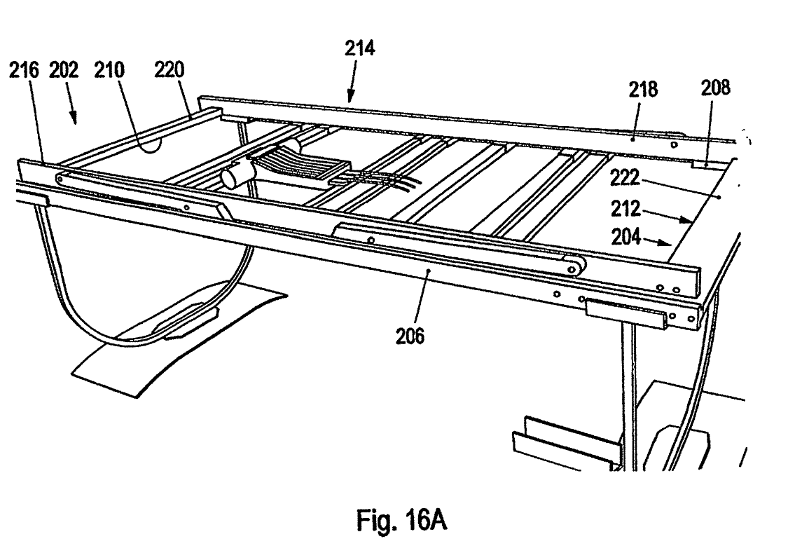

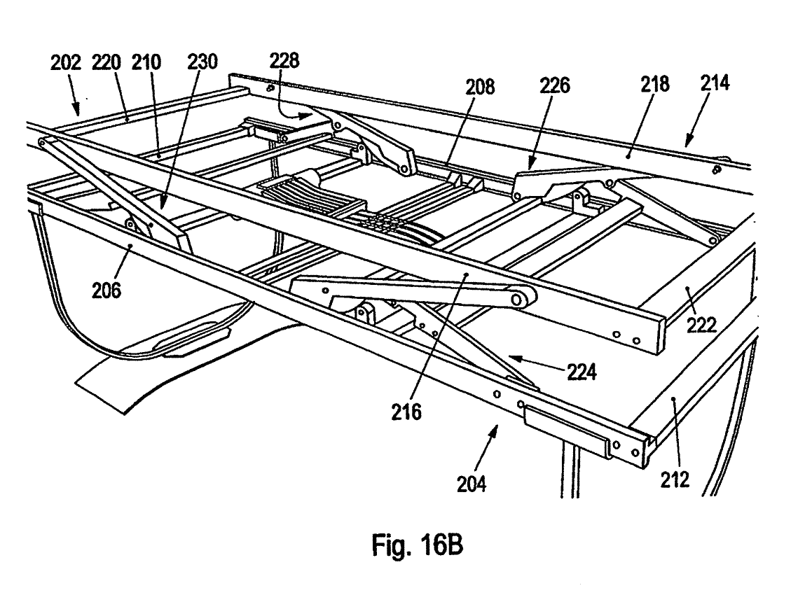

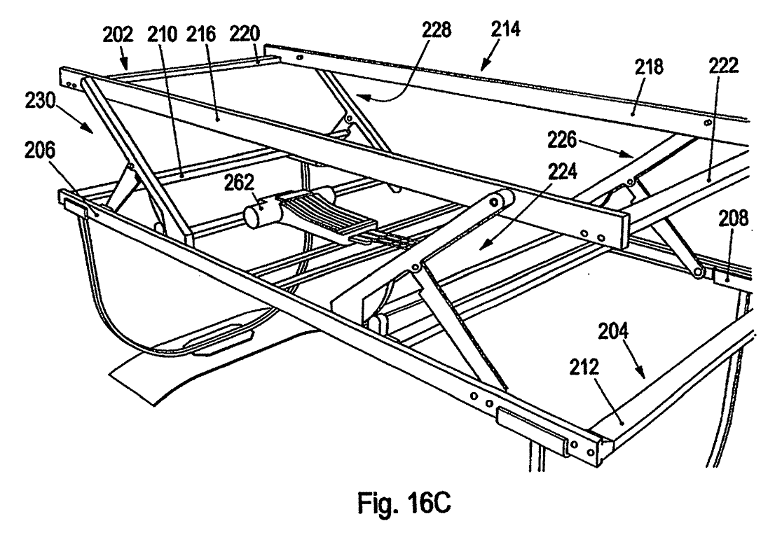

For explanation of an embodiment of a supporting device according to the invention reference is made below to FIG. 16 to 20.

FIG. 16A to 16C show an embodiment of a supporting device 202 according to the invention in a perspective view and different kinematic phases. The supporting device 202 has a main body 204, which in this embodiment is designed as a frame and has two longitudinal spars 206, 208 which are spaced apart from one another transversely with respect to the longitudinal direction of the supporting device 202 and are connected to one another at the ends of the supporting device by means of transverse spars 210, 212 (cf. in particular FIG. 16C).

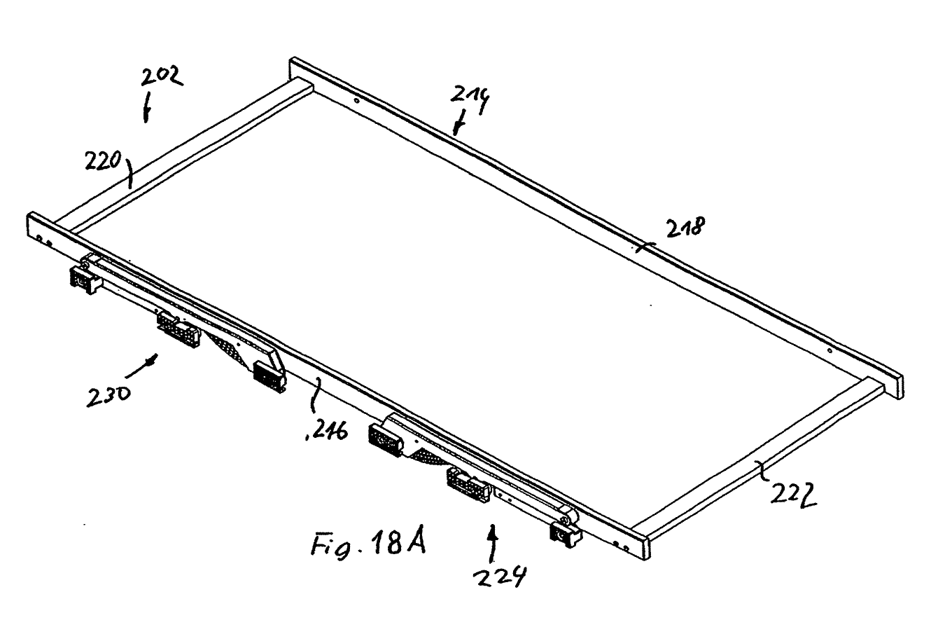

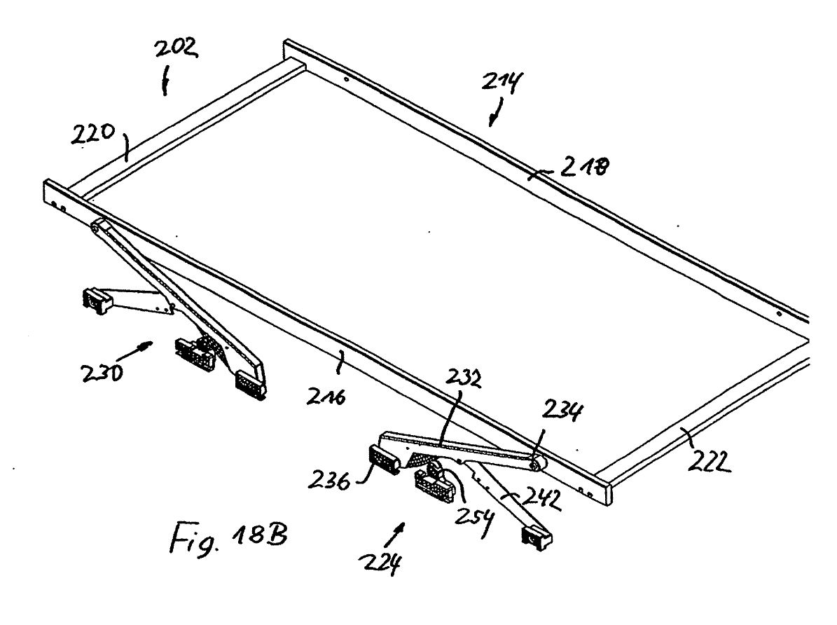

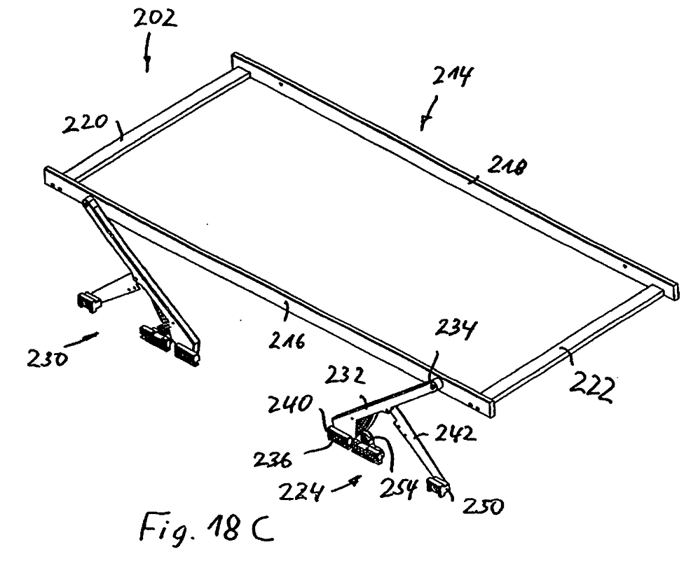

Furthermore, the supporting device 202 has a supporting arrangement 214, which is likewise designed as a frame and has two longitudinal spars 216, 218 which are spaced apart transversely with respect to the longitudinal direction of the supporting arrangement 214 and are connected to one another at the ends of the supporting arrangement 214 by means of transverse spars 220, 222 (cf. in particular FIG. 16C and FIG. 18A).

In the illustrated embodiment the supporting arrangement 214 forms a substantially horizontal support surface, which is adjustable in height relative to the main body 204. If necessary or desirable according to the respective requirements, the supporting device 214 itself can have support parts which are adjustable relative to one another, for example an upper body support part, a central support part and a leg support part as well as possibly further support parts, as is generally known, for example, in the case of slatted frames.

FIG. 16A shows the supporting device in a starting position of the adjusting movement, in which the supporting device 214 is in a lowered position. On the other hand, FIG. 16C shows an adjusted position in which the supporting arrangement 214 is adjusted in height to a maximum extent relative to the main body 204. FIG. 16B shows an adjusted position of the supporting arrangement 214 between the lowered position and the maximum raised position.

The supporting device according to the invention has an electric motor-powered adjustment means for adjusting the height of the supporting arrangement 214 relative to the main body 204. According to the invention, the adjustment means have at least one lifting arrangement which is like a scissor lift and can be actuated by a Bowden cable and which acts between the main body 204 and the supporting arrangement 214.

In the illustrated embodiment four lifting arrangements 224, 226, 228 and 230 are provided. As can be seen in particular from FIG. 16C, the lifting arrangements 224 to 230 in each case act on the supporting arrangement 214 in the region of the corners of a rectangle defining the support surface of the supporting arrangement 214, wherein the lifting arrangements 226 and 230 act on the longitudinal spar 216 and the lifting arrangements 226, 228 act on the longitudinal spar 218.

The supporting arrangement 214 is adjustable in height, that is to say it can be raised or lowered, relative to the main body 204 by synchronous actuation of the lifting arrangements 224 to 230.

Only the lifting arrangement 224 is explained in greater detail below. The lifting arrangements 226 to 230 are correspondingly constructed and therefore are not explained in greater detail here.

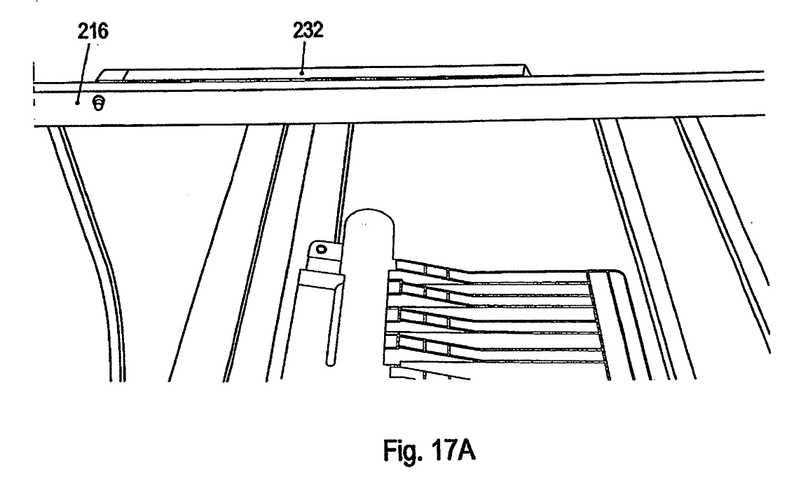

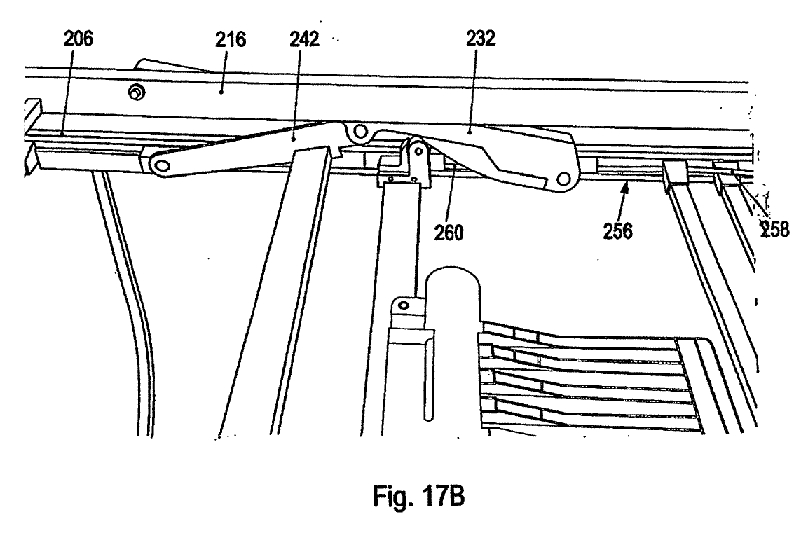

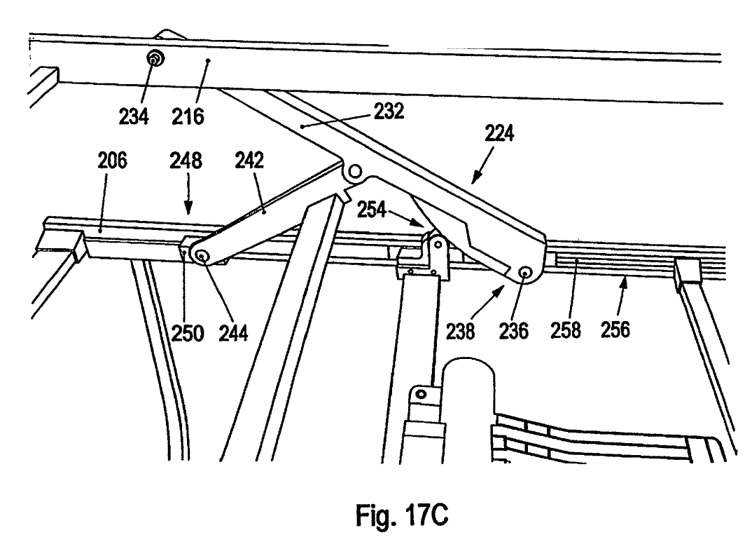

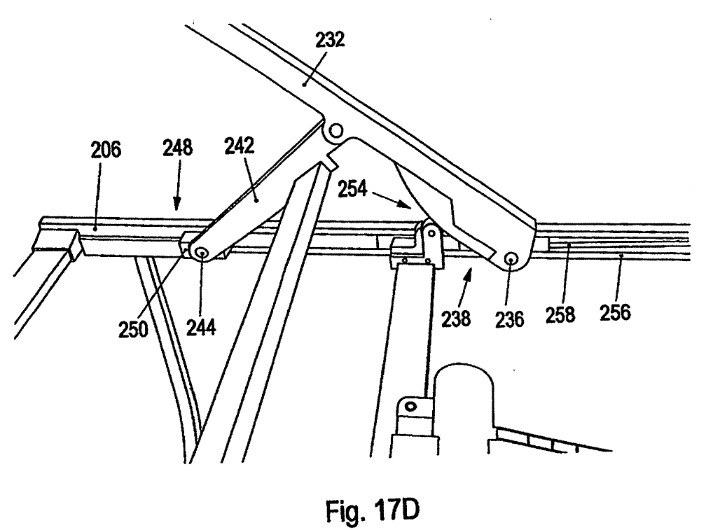

FIG. 17A to 17D show the lifting arrangement 224 in different kinematic phases of the adjusting movement, wherein FIG. 17A corresponds to an unadjusted starting position in which the supporting arrangement 214 is lowered, whilst FIG. 17D shows an end position of the adjusting movement in which the supporting arrangement 214 is raised to a maximum extent relative to the main body 204. FIGS. 17B and 17C show adjusted positions between the starting position according to FIG. 17A and the end position according to FIG. 17D.

For clarification of the functional principle of the invention, FIG. 18 merely depicts the supporting arrangement 214 in combination with the lifting arrangements 224, 230, wherein for reasons of clarity of illustration the remaining components of the supporting arrangement 202 are omitted. FIG. 18A shows the starting position of the adjusting movement, whilst FIG. 18C shows the end position of the adjusting movement and FIG. 18B shows an adjusted position located between them.

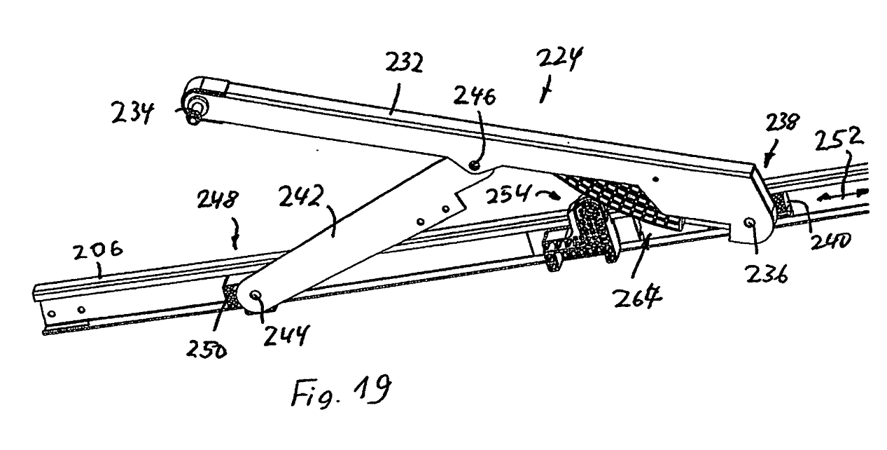

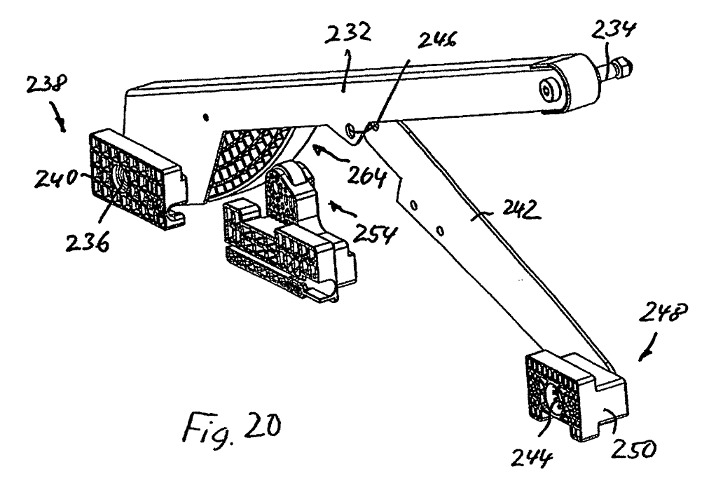

The structure of the lifting arrangement 224 is explained in greater detail below with reference to FIGS. 19 and 20.

According to the invention the lifting arrangement 224 can be actuated by a Bowden cable and is constructed like a scissor lift. The lifting arrangement 224 has an erecting lever 232 which can be erected under the pulling action of a Bowden cable in such a way that the supporting arrangement 214 is raised during erection of the erecting lever 232. The ends of the erecting lever 232 are mounted, on the one hand, so as to pivot on the main body 204 about pivot axes 234, 236 which are parallel to one another and, on the other hand, are mounted on the supporting arrangement 214. The pivot axis 236 is defined by a first rotary bearing 238 which is formed on a first bearing element 240.

The lifting arrangement 224 has a bracket 242, the ends of which pivot about pivot axes 244, 246 which are parallel to one another, on the one hand, on a second rotary bearing 248 formed on a second bearing element 250 and, on the other hand, on the erecting lever 232 remote from the ends thereof (cf. FIG. 19). The erecting lever 232 forms together with the bracket 242 a lifting arrangement which acts according to the principle of a scissor lift.

In illustrated embodiment the longitudinal spar 216 is formed by a C-profile Furthermore, in the illustrated embodiment the second bearing element 250 is fastened in a stationary manner in the C-profile. Furthermore, in the second embodiment the first bearing element 240 is caught in the C-profile and mounted along a linear axis in the direction of a double arrow 252 on the longitudinal spar 216 and thus on the main body 204.

Furthermore, a first erecting element 254 is provided which is arranged in the path of translational movement of the erecting lever 232. The erecting element 254 is caught in the C-profile of the longitudinal spar 216 and is movable in the direction of the double arrow 252 relative to the translationally movable first bearing element 240 and the stationary second bearing element 215.

For actuation of the lifting arrangement 224 a Bowden cable 256 (cf. FIG. 17B) is provided which in a known manner has a sheath 258 which can be subjected to pressure and in which a traction cable (core) 260 is received. One end of the sheath 258 is secured on the first bearing element 240 (cf. FIG. 17B), whilst the other end of the sheath is secured on a housing of an electric motor-powered driving apparatus 262 (cf. FIG. 16C). The electric motor-powered driving apparatus 262 can be designed, for example and in particular, as depicted in FIG. 8 ff. of EP 2 792 277 A1, the entire content of which is incorporated by reference into the present application. The end of the traction cable 260 remote from the driving apparatus 262 is secured to the first erecting element 254.

For interaction with the first erecting element 254 the erecting lever 232 has a second erecting element 264 which is connected thereto for conjoint rotation therewith and in this embodiment is designed as a cam member. With regard to the configuration and function of the erecting elements 254, 264 reference is made to the illustrative examples according to FIG. 1 to 15. The features and functions disclosed there correspond to the embodiment according to the invention or are transferable to the embodiment according to the invention.

If a pulling force is exerted on the traction cable 260 of the Bowden cable 256 by the electric motor-powered drive unit 262 starting from the starting position of the adjusting movement (cf. FIG. 16A), the distance between the first erecting element 254 and the first bearing element 240 decreases, wherein the erecting lever runs onto the first erecting element 254 and is erected, as can be seen, for example, from FIG. 19. In this case the first bearing element 240 in FIG. 19 moves towards the left in the direction on the stationary second bearing element 250, whilst the first erecting element 250 in FIG. 19 moves towards the right, until the end position of the adjusting movement depicted, for example, in FIG. 16C is reached.

In order to raise the supporting arrangement uniformly, the Bowden cables which actuate the lifting arrangements 224 to 230 are actuated synchronously. In this way twisting of the supporting arrangement 214 during a height adjustment is avoided. In order to achieve synchronous actuation of the four Bowden cables, an electric motor-powered drive unit according to FIG. 9 of EP 2 792 277 A1 can be used, for example, in which two electric motors in each case drive a spindle nut and each spindle nut actuates two Bowden cables. Thus, four Bowden cables can be actuated synchronously by synchronous control of the two electric motors. For example, however, an electric motor-powered driving apparatus can also be used, such as is depicted in FIG. 16 of EP 2 792 277 and in which an individual electric motor drives two winding drums and each winding drum actuates two Bowden cables. According to the invention, however, any other suitable driving apparatus can be used, and, for example, a separate driving apparatus can be associated with each lifting arrangement 224 to 230, wherein these driving apparatuses are actuated synchronously for lifting the supporting arrangement 214.

The return of the supporting arrangement 214 from the raised position depicted in FIG. 16C into the lowered starting position depicted in FIG. 16A takes place with the driving apparatus switched on under the weight of the supporting device 214 and possibly the weight of a person resting on the supporting arrangement 214.

In the various figures of the drawings and the various embodiments the same or corresponding components are provided with the same reference numerals. In so far as components are omitted in the figures of the drawings for reasons of clarity of depiction or illustration, the relevant components should be added analogously in each case in the other figures. It can be seen by the person skilled in the art that the features of the individual illustrative examples and embodiments are also interchangeable among the illustrative examples and embodiments, that is to say the features disclosed in relation to an embodiment or illustrative example can also be provided identically or analogously in the other embodiments or illustrative examples. Furthermore, it can be seen by the person skilled in the art that the features disclosed with regard to the den individual embodiments or illustrative examples in each case further embody the invention by itself, that is to say independently of the further features of the respective embodiment or illustrative example.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention.

1. Supporting device adjustable by an electric motor and intended for supporting an upholstered unit of a piece of furniture for sitting and/or lying on, comprising:
a) a main body;
b) a supporting arrangement for supporting the upholstered unit;
c) an adjustment device for adjusting an inclination and/or height of the supporting arrangement relative to the main body;
d) the adjustment device having at least one lifting arrangement which is like a scissor lift and can be actuated by a Bowden cable and which acts between the main body and the supporting arrangement.

2. Supporting device according to claim 1, wherein:
a) at least two lifting arrangements are provided which are spaced apart from one another transversely with respect to a longitudinal direction of the supporting arrangement.

3. Supporting device according to claim 1, wherein:
a) at least two lifting arrangements are provided which are spaced apart from one another in a longitudinal direction of the supporting arrangement.

4. Supporting device according to claim 1, wherein:
a) the supporting arrangement has longitudinal spars spaced apart from one another laterally and that the or each lifting arrangement acts or act on the longitudinal spars.

5. Supporting device according to claim 1, wherein:
a) the lifting arrangement has an erecting lever which can be erected under pulling action of a Bowden cable, in such a way that the supporting arrangement can be raised or is raised during erection of the erecting lever or can be adjusted or is adjusted in its inclination.

6. Supporting device according to claim 5, wherein:
a) ends of the erecting lever are mounted, on the one hand, so as to pivot on the main body about pivot axes which are parallel to one another and, on the other hand, are mounted on the supporting arrangement.

7. Supporting device according to claim 5, wherein:
a) the erecting lever is mounted pivotably on the main body on a first rotary bearing.

8. Supporting device according to claim 7, wherein:
a) a bracket is provided, ends of which pivot about pivot axes which are parallel to one another, on the one hand, on a second rotary bearing on the main body and, on the other hand, are mounted on the erecting lever remote from the ends thereof.

9. Supporting device according to claim 8, wherein:
a) the first rotary bearing and the second rotary bearing are mounted on the main body so as to be movable in translation relative to one another along a linear axis.

10. Supporting device according to claim 9, wherein:
a) with regard to the adjustment of the supporting arrangement relative to the main body the first rotary bearing is arranged movably and the second rotary bearing is arranged stationary on the main body.

11. Supporting device according to claim 6, wherein:
a) the erecting lever or a component connected thereto, during its translational movement relative to the second rotary bearing, runs onto a first erecting element and is erected.

12. Supporting device according to claim 11, wherein:
a) the first erecting element is mounted so as to be movable along the translational axis relative to the first rotary bearing.

13. Supporting device according to claim 12, wherein:
a) under the pulling action of the Bowden cable the distance between the first rotary bearing and the erecting element decreases, in such a way that the erecting lever runs onto the erecting element and is erected.

14. A bed, wherein:
a) the bed has a supporting device according to claim 1.
